(19) United States
(12) Patent Application Publication
(10) Pub. No.: US 2014/0147824 A1
(43) Pub. Date: May 29, 2014

(54) INDEPENDENT E-LEARNING STANDARD ENGINES

(71) Applicant: Pradeep KUMAR T, Mahabubnagar (IN)

(72) Inventor: Pradeep KUMAR T, Mahabubnagar (IN)

(21) Appl. No.: 13/688,172

(22) Filed: Nov. 28, 2012

(51) Int. Cl. G09B 5/04

(52) U.S. Cl. CPC G09B 5/04
USPC 434/350

(57) ABSTRACT

Various embodiments of systems and methods for developing independent e-learning standard engines are described herein. The method includes loading e-learning standard compliant content into a content player. Further, the method involves selecting one of several strategy engines that support delivering the loaded e-learning standard compliant content. The strategy engines are developed as independent tools configured to operate with a content player, irrespective of a type of the content player, to deliver the content. Further, a portion of the content and one or more user interface elements are presented on a user interface, where the one or more user interface elements are configured to navigate the content according to a learning strategy provided by the selected strategy engine.

### FIELD

The disclosure generally relates to electronic learning systems, and more specifically to developing e-learning standard engines that are independent of the e-learning player.

### BACKGROUND

Today, an enterprise's survival in local or global markets at least partially depends on the knowledge and competencies of its employees, which may be considered a competitive factor for the enterprises (or other organizations). Moreover, enterprise globalization and the resulting international competitive pressure are making rapid global knowledge transfer even more significant. Thus, enterprises are often faced with the challenge of training a (perhaps globally) distributed workforce, update partners and suppliers about new products and developments, educate apprentices or new hires, or set up new markets. In other words, efficient and targeted learning is a challenge that learners, employees, and employers are equally faced with. But traditional classroom training typically ties up time and resources, takes employees away from their day-to-day tasks, and drives up expenses.

Electronic learning systems provide users with the ability to access course content directly from their computers, without the need for intermediaries such as teachers, tutors, and the like. Such systems have proven attractive for this reason (and perhaps others) and may include a master repository that stores existing versions of learning objects. These learning objects are typically developed in-house or received from third-party providers to achieve some particular learning objective. This course content can be presented in a display region of an interactive content player. The content player allows a user to navigate the content by selecting interactive navigation controls. The navigation controls can allow a user to move forward or backward through the content, or present a table of contents to the user.

In order to make sure that all e-learning content and e-learning content players are compatible with each other, the e-learning content and the e-learning players are conformed to any of the available technical standards for e-learning products. For example, Sharable Content Object Reference Model (SCORM) is one such technical standard for e-learning interoperability. Specifically, SCORM governs how online learning content and Learning Management Systems (LMSs) communicate with each other.

However, developing an e-learning player which can play e-learning standard conformant contents like SCORM or Aviation industry CBT Committee (AICC) takes a lot of maintenance effort. This is because the e-learning standards are subject to enhancements and improvements from time to time and the e-learning standard is tightly coupled with the basic e-learning player. For example, the e-learning player contains technical and functional dependencies in terms of programming language, program logic, and variations in functionality for different e-learning standards.

### SUMMARY

Various embodiments of systems and methods for developing independent e-learning standard engines are described herein. In an embodiment, the method includes loading e-learning standard compliant content into a content player. Further, the method involves selecting one of several strategy engines that support delivering the loaded e-learning standard compliant content. The strategy engines are developed as independent tools configured to operate with a content player, irrespective of a type of the content player, to deliver the content. In an aspect, a portion of the content and one or more user interface elements are presented on a user interface, where the one or more user interface elements are configured to navigate the content according to a learning strategy provided by the selected strategy engine. In yet another aspect, the user interface of the content player is modified in accordance with a command from the learning content, where the user interface includes a plurality of interface elements and at least a subset of the interface elements comprising navigational controls for controlling the learning content.

A computer system may operate to implement the method described above. The computer system may store, execute or be otherwise controlled by one or more computer programs that control the computer system to implement the method described above.

These and other benefits and features of embodiments will be apparent upon consideration of the following detailed description of preferred embodiments thereof, presented in connection with the following drawings.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a diagram illustrating an example learning environment according to one embodiment of the present disclosure.

FIG. 2 illustrates an exemplary architecture of a learning management system implemented within the learning environment of FIG. 1.

FIG. 3 illustrates an example run-time environment for the content player and the learning portal implemented within a learning environment.

FIG. 4 illustrates an exemplary user interface with one or more sets of navigation controls.

FIG. 5 is a flow diagram of processing in accordance to various embodiments.

FIG. 6 is a block diagram illustrating a computing environment in which the techniques described for generating information models in an in-memory database system can be implemented, according to an embodiment.

### DETAILED DESCRIPTION

Embodiments of techniques for developing independent e-learning standard engines are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

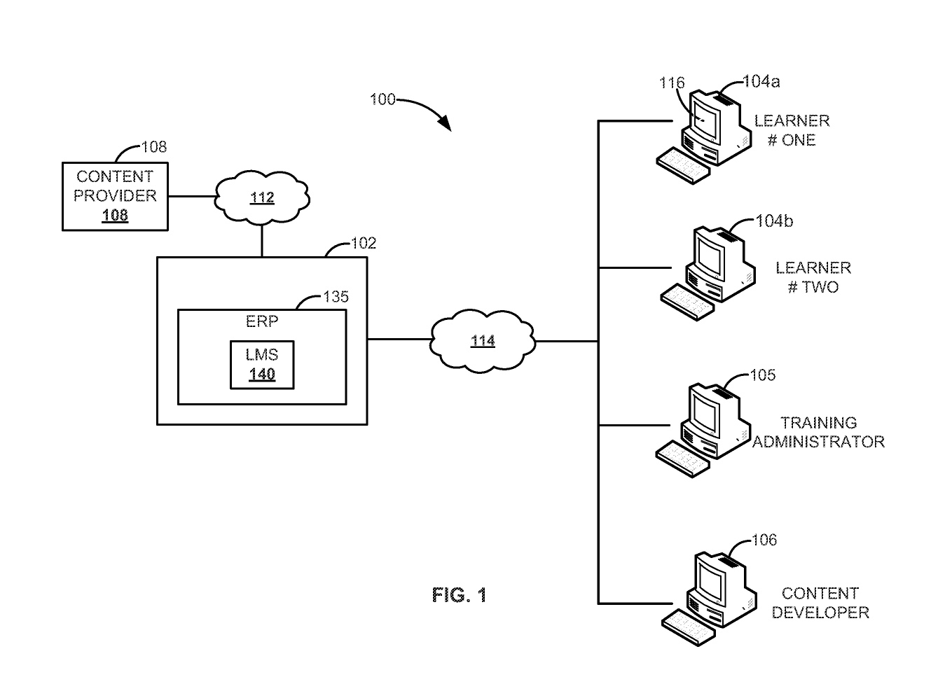

FIG. 1 illustrates an example environment for a learning management system (LMS) 140 that may deliver a blended learning solution of learning methods used in traditional classroom training, web-based training, and virtual classrooms. At a high level, such applications 140 provide convenient information on the learner 104's virtual workplace and at least partially control the learning process itself. The system proposes learning units based on the learner 104's selection of a course content, tracks progress through courses and coordinates the personalized learning experience. In addition, learning management system 140 encompasses the administrative side of the learning platform, where a training administrator 105 structures and updates the offering and distributes it among the target groups. Moreover, the course offering is usually not restricted to internally hosted content. The learning management system 140 often offers robust reporting capabilities, including ad hoc reporting and business intelligence. These capabilities may provide in-depth analysis of the entire business or organization, thereby enabling better decision making. Learning management system 140 typically helps improve the quality of training and cut costs by reducing the travel and administrative costs associated with classroom training while delivering a consistent learning offering.

Such electronic learning systems present learning content in various different formats from multiple sources, both internal and external. This content may be presented to learner 104 using a content player comprising a media player, a browser implementing various scripts and programming, or other such interfaces. Such content players often include a content presentation screen, as well as a header and navigation bar. In these implementations, the header bar may show the title of the learning content and the navigation bar may be used to navigate between learning units, to open the table of contents screen, and to implement logging off.

Training administrators 105 may customize teaching scenarios by using web services to integrate external content, functions, and services into the learning platform from a remote or third party content provider 108. The training administrator 105 can administer internal and external participants (or learners 104) and enroll them for courses to be delivered via any number of techniques. Training management supports the respective organization, entity, or learner 104 in the day-to-day activities associated with course bookings. Booking activities can be performed by the training administrator in training management on an individual or group participant basis. For example, training administrator 105 can often request, execute, or otherwise manage the following activities in a dynamic participation menu presented in learning management system 140: i) pre-book: if participants are interested in taking certain classroom courses or virtual classroom sessions, but there are no suitable dates scheduled, 30 learners 104 can be pre-booked for the course types. Pre-booking data can be used to support a demand planning process; ii) book: individual or group learners 104 (for example, companies, departments, roles, or other organizational units) can be enrolled for courses that can be delivered using many technologies; iii) re-book: learners 104 can book a course on an earlier or later date than originally booked; iv) replace: learners 104 can be swapped; and v) cancel: course bookings can be canceled, for example, if the learners 104 cannot attend.

Environment 100 is typically a distributed client/server system that spans one or more networks such as external network 112 or internal network 114. In such embodiments, data may be communicated or stored in an encrypted format such as, for example, using the RSA, WEP, or DES encryption algorithms. But environment 100 may be in a dedicated enterprise environment—across a local area network or subnet—or any other suitable environment without departing from the scope of this disclosure. Indeed, while generally described or referenced in terms of an enterprise, the components and techniques may be implemented in any suitable environment, organization entity, and such. Turning to the illustrated embodiment, environment 100 includes or is communicably coupled with server 102, one or more learners 104 or other users on clients, and network 112. In this embodiment, environment 100 is also communicably coupled with external content provider 108.

Server 102 comprises an electronic computing device operable to receive, transmit, process and store data associated with environment 100. Generally, FIG. 1 provides merely one example of computers that may be used with the disclosure. Each computer is generally intended to encompass any suitable processing device. For example, although FIG. 1 illustrates one server 102 that may be used with the disclosure, environment 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute any operating system including Linux, UNIX, Windows Server, or any other suitable operating system. According to one embodiment, server 102 may also include or be communicably coupled with a web server and/or a mail server. Server 102 may also be communicably coupled with a remote repository over a portion of network 112. While not illustrated, the repository may be any intra-enterprise, inter-enterprise, regional, nationwide, or other electronic storage facility, data processing center, or archive that allows for one or a plurality of clients (as well as servers 102) to dynamically store data elements, which may include any business, enterprise, application or other transaction data. For example, the repository may be a central database communicably coupled with one or more servers 102 and clients via a virtual private network (VPN), SSH (Secure Shell) tunnel, or other secure network connection. This repository may be physically or logically located at any appropriate location including in one of the example enterprises or off-shore, so long as it remains operable to store information associated with environment 100 and communicate such data to at least a subset of plurality of the clients (perhaps via server 102).

As a possible supplement to or as a portion of this repository, server 102 normally includes some form of local memory. The memory may include any memory or database module and may take the form of volatile or non-volatile memory including, without limitation, magnetic media, optical media, random access memory (RAM), read-only memory (ROM), removable media, or any other suitable local or remote memory component. For example, the memory may store or reference a large volume of information relevant to the planning, management, and follow-up of courses or other content. This example data includes information on i) course details, such as catalog information, dates, prices, capacity, time schedules, assignment of course content, and completion times; ii) personnel resources, such as trainers who are qualified to hold Courses; iii) room details, such as addresses, capacity, and equipment; and iv) participant data for internal and external participants. The memory may also include any other appropriate data such as VPN applications or services, firewall policies, a security or access log, print or other reporting files, HTML files or templates, data classes or object interfaces, child software applications or sub-systems, and others, in some embodiments, the memory may store information as one or more tables in a relational database described in terms of SQL statements or scripts. In another embodiment, the memory may store information as various data structures in text files, eXtensible Markup Language (XML) documents, Virtual Storage Access Method (VSAM) files, flat files, Btrieve files, comma-separated-value (CSV) files, internal variables, or one or more libraries. But any stored information may comprise one table or file or a plurality of tables or files stored on one computer or across a plurality of computers in any appropriate format. Indeed, some or all of the learning or content data may be local or remote without departing from the scope of this disclosure and store any type of appropriate data.

Server 102 also includes one or more processors. Each processor executes instructions and manipulates data to perform the operations of server 102 such as, for example, a central processing unit (CPU), a blade, an application specific integrated circuit (ASIC), or a field-programmable gate array (FPGA). Although this disclosure typically discusses computers in terms of a single processor, multiple processors may be used according to particular needs and reference to one processor is meant to include multiple processors where applicable. In the illustrated embodiment, the processor executes enterprise resource planning (ERP) solution 135, thereby providing organizations with the strategic insight, ability to differentiate, increased productivity, and flexibility they need to succeed. With software such as ERP solution 135, the implementing entity may automate end-to-end processes and extend those processes beyond the particular organization to the entire system by incorporating customers, partners, suppliers, or other entities. For example, ERP solution 135 may include or implement easy-to-use self-services and role-based access to information and services for certain users, thereby possibly boosting productivity and efficiency. In another example, ERP solution 135 may include or implement analytics that enable the particular entity or user to evaluate performance and analyze operations, workforce, and financials on an entity and individual level for strategic and operational insight, ERP solution 135 may further include or implement i) financials to control corporate finance functions while providing support for compliance to rigorous regulatory mandates; ii) operations to support end-to-end logistics for complete business cycles and capabilities that improve product quality, costs, and time to market; and/or iii) corporate services to optimize both centralized and decentralized services for managing real estate, project portfolios, business travel, environment, health and safety, and quality, in the illustrated embodiment, ERP solution 135 also includes or implements some form of human capital management (in this case, learning) to maximize the profitability or other measurable potential of the users, with support for talent management, workforce deployment, and workforce process management. In certain cases, ERP solution 135 may be a composite application that includes, execute, or otherwise implement some or all of the foregoing aspects, which include learning management system 140 as illustrated.

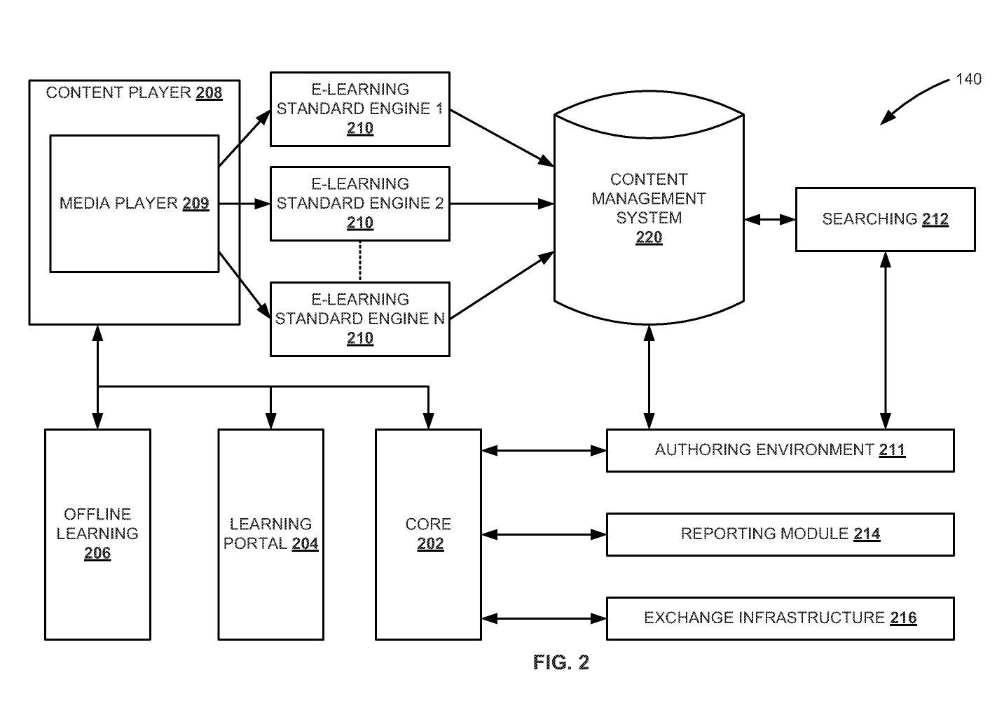

As briefly described above, learning management system 140 is any software operable to provide a comprehensive enterprise learning platform capable of managing and integrating business and learning processes and supporting all methods of learning, not restricted to e-learning or classroom training. As described in more detail in FIG. 2, learning management system 140 is often fully integrated with ERP solution 135 and includes an intuitive learning portal and a powerful training and learning management system, as well as content authoring, structuring, and management capabilities.

Regardless of the particular implementation, “software” may include software, firmware, wired or programmed hardware, or any combination thereof as appropriate. Indeed, ERP solution 135 may be written or described in any appropriate computer language including C, C++, Java, J#, Visual Basic, assembler, Perl, any suitable version of 4GL, as well as others. For example, returning to the above described composite application, the composite application portions may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's NET. It will be understood that while ERP solution 135 is illustrated in FIG. 1 as including one sub-module learning management system 140, ERP solution 135 may include numerous other sub-modules or may instead be a single multi-tasked module that implements the various features and functionality through various objects, methods, or other processes. Further, while illustrated as internal to server 102, one or more processes associated with ERP solution 135 may be stored, referenced, or executed remotely. For example, a portion of ERP solution 135 may be a web service that is remotely called, while another portion of ERP solution 135 may be an interface object bundled for processing at the remote client. Moreover, ERP solution 135 and/or learning management system 140 may be a child or sub-module of another software module or enterprise application (not illustrated) without departing from the scope of this disclosure.

Server 102 may also include an interface for communicating with other computer systems, such as the clients, over networks, such as 112 or 114, in a client-server or other distributed environment. In certain embodiments, server 102 receives data from internal or external senders through the interface for storage in the memory and/or processing by the processor. Generally, the interface comprises logic encoded in software and/or hardware in a suitable combination and operable to communicate with networks 112 or 114. More specifically, the interface may comprise software supporting one or more communications protocols associated with communications network 112 or hardware operable to communicate physical signals.

Network 112 facilitates wireless or wireline communication between computer server 102 and any other local or remote computers, such as clients. Network 112, as well as network 114, facilitates wireless or wireline communication between computer server 102 and any other local or remote computer, such as local or remote clients or a remote content provider 108. While the following is a description of network 112, the description may also apply to network 114, where appropriate. For example, while illustrated as separate networks, network 112 and network 114 may be a continuous network logically divided into various sub-nets or virtual networks without departing from the scope of this disclosure, in some embodiments, network 112 includes access points that are responsible for brokering exchange of information between the clients. As discussed above, access points may comprise conventional access points, wireless security gateways, bridges, wireless switches, sensors, or any other suitable device operable to receive and/or transmit wireless signals, in other words, network 112 encompasses any internal or external network, networks, sub-network, or combination thereof operable to facilitate communications between various computing components in system 100. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. Turning to network 114, as illustrated, it may be all or a portion of an enterprise or secured network. In another example, network 114 may be a VPN between server 102 and a particular client across wireline or wireless links. In certain embodiments, network 114 may be a secure network associated with the enterprise and certain local or remote clients.

Each client is any computing device operable to connect or communicate with server 102 or other portions of the network using any communication link. At a high level, each client includes or executes at least GUI 116 and comprises an electronic computing device operable to receive, transmit, process and store any appropriate data associated with environment 100. It will be understood that there may be any number of clients communicably coupled to server 102. Further, “client” and “learner,” “administrator,” “developer” and “user” may be used interchangeably as appropriate without departing from the scope of this disclosure. Moreover, for ease of illustration, each client is described in terms of being used by one user. But this disclosure contemplates that many users may use one computer or that one user may use multiple computers. As used in this disclosure, the client is intended to encompass a personal computer, touch screen terminal, workstation, network computer, kiosk, wireless data port, smart phone, personal data assistant (PDA), one or more processors within these or other devices, or any other suitable processing device or computer. For example, the client may be a PDA operable to wirelessly connect with external or unsecured network. In another example, the client may comprise a laptop that includes an input device, such as a keypad, touch screen, mouse, or other device that can accept information, and an output device that conveys information associated with the operation of server 102 or other clients, including digital data, visual information, or GUI 116. Both the input device and output device may include fixed or removable storage media such as a magnetic computer disk, CD-ROM, or other suitable media to both receive input from and provide output to users of the clients through the display, namely the client portion of GUI or application interface 116.

GUI 116 comprises a graphical user interface operable to allow the user of the client to interface with at least a portion of environment 100 for any suitable purpose, such as viewing application or other transaction data. Generally, GUI 116 provides the particular user with an efficient and user-friendly presentation of data provided by or communicated within environment 100. As shown in later FIGUREs. GUI 116 may comprise a plurality of customizable frames or views having interactive fields, pull-down lists, and buttons operated by the user. GUI 116 may be a learning interface allowing the user or learner 104 to search a course catalog, book and cancel course participation, and support individual course planning (e.g., by determining qualification deficits and displaying a learner's completed, started, and planned training activities). Learner 104 also may access and work through web based courses using the learning interface. The learning interface may be used to start a course, re-enter a course, exit a course, and take tests. The learning interface also provides messages, notes, and special course offerings to the learner 104. GUI 116 may also be a course editor allowing the content developer to create the structure for the course content according to an e-learning standard (e.g., SCORM), which may be associated with certain metadata. The metadata may be interpreted by a content player of learning management system 140 (described below) to present a course to learner 104 according to the e-learning standard (learning strategy).

In particular, the course editor may enable the author or content developer 106 to classify and describe structural elements, assign attributes to structural elements, assign relations between structural elements, and build a subject-taxonomic course structure, according to the c-learning standard. The course editor generates the structure of the course and may include a menu bar, a button bar, a course overview, a dialog box, and work space. The menu bar may include various drop-down menus, such as, for example, file, edit, tools, options, and help. The drop-down menus may include functions, such as create a new course, open an existing course, edit a course, or save a course. The button bar may include a number of buttons. The buttons may be shortcuts to functions in the drop down menus that are used frequently and that activate tools and functions for use with the course editor. The remaining portions of the example course editor interface may be divided in to three primary sections or windows: a course overview, a dialog box, and a workspace. Each of the sections may be provided with horizontal or vertical scroll bars or other means allowing the windows to be sized to fit on different displays while providing access to elements that may not appear in the window.

GUI 116 may also present a plurality of portals or dashboards. For example, GUI 116 may display a portal that allows users to view, create, and manage historical and real-time reports including role-based reporting and such. It should be understood that the term graphical user interface may be used in the singular or in the plural to describe one or more graphical user interfaces and each of the displays of a particular graphical user interface. Indeed, reference to GUI 116 may, indicate a reference to the front-end or other component of learning management system 140, as well as the particular interface or learning portal accessible via the client, as appropriate, without departing from the scope of this disclosure, in short, GUI 116 contemplates any graphical user interface, such as a generic web browser or touch screen that processes information in environment 100 and efficiently presents the results to the user.

FIG. 2 illustrates one example implementation of learning management system (LMS) 140. In the illustrated embodiment, LMS 140 comprises four example components, namely i) a management system core 202, which controls learning processes and manages and handles the administrative side of training; ii) a learning portal 204, which is the learner's springboard into the learning environment, which allows him to access the course offering and information on personal learning data and learning activities; iii) an authoring environment 211, where learning content and tests are designed and structured; iv) a content management system 220, where learning content is stored and managed; and v) a content player 208 integrated with a e-learning standard engine 210. Generally, LMS 140 is aimed at learners 104, trainers 105, course authors 106 and instructional designers, administrators, and managers.

Learners 104 log on to their personalized learning portal 204 from any suitable client via GUI 116. The learning portal 204 is the user's personalized point of access to the learning-related functions. Generally, learning portal 204 presents details of the complete education and training offering, such as traditional classroom training, e-learning courses (such as virtual classroom sessions or web-based training), or extensive curricula. Self-service applications enable learners 104 to enroll themselves for courses, pre-book for classroom courses, and cancel bookings for delivery methods, as well as start self-paced learning units directly. If learner 104 wants to continue learning offline, he can often download the courses onto the client and synchronize the learning progress later. The learning portal 204 may be seamlessly integrated in an enterprise portal, where learner 104 is provided with access to a wide range of functions via one system. Such an enterprise portal may be the learner's single point of entry and may integrate a large number of role-based functions, which are presented to the user in a clear, intuitive structure. The learning portal 204 often gives learner 104 access to functions such as, for example, search for courses using i) find functions: finding courses in the course catalog that have keywords in the course title or description; and ii) extended search functions: using the attributes appended to courses, such as target group, prerequisites, qualifications imparted, or delivery method. Additional functions may include self-service applications for booking courses and canceling bookings, messages and notes, course appraisals, and special (or personalized) course offering including courses prescribed for the learner 104 on the basis of his or her role in the enterprise or the wishes of the respective supervisor or trainer and qualification deficits of learner 104 that can be reduced or eliminated by participating in the relevant courses. The learning portal 204 may also provide a view of current and planned training activities, as well as access to courses booked, including: i) starting a course; ii) reentering an interrupted course; iii) downloading a course and continuing learning offline; iv) going online again with a downloaded course and synchronizing the learning progress; v) exiting a course; and vi) taking a test.

In response to a learner 104's enrollment to a particular course, the learning management system core 202 proposes learning units for the learner 104, monitors the learner's progress, and coordinates the learner's personal learning process, in addition, the learning management system core 202 is often responsible for managing and handling the administrative processes. The resulting course is then presented to the learner 104 via a content player 208.

The content player 208 is a media player that enables a user (trainer or learner) to deliver e-learning standard compliant courses using a LMS or a static web server. The content player reads the content file and generates a table of contents and necessary navigation controls automatically using program logic developed based on the e-learning standard. The Sharable Content Object Reference Model (SCORM) is by far the most widely accepted technical specification for content interoperability. This means there may be a large quantity of SCORM compliant content that is commercially available and can be installed and run on many different course management systems with little or no further customization. SCORM is a set of technical standards for e-learning software products. SCORM tells programmers how to write their code so that it can “play well” with other e-learning software. It is the de facto industry standard for e-learning interoperability. Specifically, SCORM governs how online learning content and Learning Management Systems (LMSs) communicate with each other.

For example, when a new movie on a DVD is purchased, one may not need to check to see if the DVD works with a particular brand of DVD player. A regular DVD will play on a Toshiba™ the same as it will on a Panasonic™. That's because DVD movies are produced using a set of standards. Without these standards a studio releasing a new movie on DVD would have several issues. The studio may need to make differently formatted DVDs for each brand of DVD player. In a similar manner, the SCORM standard makes sure that all e-learning content and LMSs can work with each other, just like the DVD standard makes sure that all DVDs will play in all DVD players. If an LMS is SCORM conformant, it can play any content that is SCORM conformant, and any SCORM conformant content can play in any SCORM conformant LMS.

SCORM stands for “Sharable Content Object Reference Model”. “Sharable Content Object” indicates that SCORM is all about creating units of online training material that can be shared across systems. SCORM defines how to create “sharable content objects” or “SCOs” that can be reused in different systems and contexts. “Reference Model” reflects the fact that SCORM isn't actually a standard. One of SCORM's sub-specification “Sequencing” specifies how the learner can navigate between parts of the course (SCOs). It is defined by a set of rules and attributes written in XML. The sequencing specification allows the content author to govern how the learner is allowed to navigate between sharable content objects (SCOs) and how progress data is rolled up to the course level. Sequencing rules are represented by XML within the course's manifest. Sequencing operates on a tracking model that closely parallels the CMI data reported by SCOs during run-time. Sequencing rules allow the content author to:
Determine which navigational controls the LMS should provide to the user (previous/next buttons, a navigable table of contents, etc.).
Specify that certain activities must be completed before others (prerequisites).
Make some parts of a course count more than others toward a final status or score (creating optional sections or providing question weighting).
Randomly select a different subset of available SCOs to be delivered on each new attempt (to enable test banking, for instance).
Take the user back to instructional material that was not mastered (r mediation).

In certain embodiments, the content player 208 is a Java application that is deployed on a Java runtime environment, such as J2EE. In this case, it is linked with other systems such as a web application server and ERP solution 135 via the Java Connector.

In an embodiment, as shown in FIG. 2, the content player 208 is split into a media player component 209 and one or more independent e-learning standard engines 210. The one or more e-learning standard engines 210 are each compliant with multiple e-learning standards or multiple versions of an e-learning standard and are independent of the type of content player 208. In other words, the e-learning standard engines are configured to function independently according to a programming language and program logic developed for a particular e-learning standard's specification. For example, the one or more independent engines 210 may each be compliant with different standard specifications such as SCORM 1.2, SCORM 2004, and AICC standard specifications. In an aspect, the media player 209 provides a user interface for rendering the course content and may offer the flexibility to a customer to modify the user interface of the player according to the customer's needs. The media player 209 can be integrated with any of the independent engines 210 using industry standard integration techniques, such as web services. Developing the e-learning standard engines 210 as independent tools enables easy integration with any e-learning content player without having to develop the content player as a whole with a program logic tailored to a particular type of content player (e.g., mobile based e-learning content player). Further, the same e-learning standard engine can be re-used for developing any type of and any number of e-learning content players. Further, whenever anew standard is available in the market, a content developer can design a new e-learning standard engine for an existing content player 208.

Once the content player 208 is integrated with a selected one of the engines 210, the individual course navigation may be set up at runtime on the basis of the learning strategy specified by the e-learning standard adopted by the selected engine 210. Using the didactical strategies dictated by the programming language and program logic provided by the selected engine 210, the content player 208 dynamically adjusts learning paths and presents these to the learner 104—perhaps graphically—to facilitate orientation within a complex subject area.

Offline learning player 206 generally enables learners 104 to download network or other web-based courses from the learning portal 204 and play them locally. Locally stored courses are listed in the course list with an icon indicating the status of each course. The offline player 206 may guide the learner 104 through the course according to the e-learning strategy provided by the en-learning standard engine 210, it may also dynamically adjust the number and sequence of learning objects to the learner's individual learning pattern. If the learner 104 interrupts a course, the offline player 206 reenters the course at the point of interruption the next time. The learner 104 can, at any point in time, resynchronize his offline learning progress with the learning portal 204 and either continue learning online or set the course to a completed status.

LMS core 202 may also include or invoke training management that would be an administrative side of LMS 140. This typically includes course planning and execution, booking and cancellation of course participation, and follow-up processing, including cost settlement. In training management, the training administrator 105 creates the course offering and can, for example, define training measures for individual learners 104 and groups of learners 104. The training administrator 105 creates the course catalog in training management and makes it available (partially or completely) to learners 104 in the learning portal 204 for reference and enrollment purposes. The training administrator 105 can typically administer internal and external participants and enroll them for courses to be delivered using various technologies and techniques. Training management supports numerous business processes involved in the organization, management, and handling of training. Training management can be configured to meet the requirements, work processes, and delivery methods common in the enterprise. Training measures are usually flexibly structured and may include briefings, seminars, workshops, virtual classroom sessions, web-based trainings, external web-based trainings, static web courses, or curricula. Training management includes functions to efficiently create the course offerings. Using course groups to categorize topics by subject area enables flexible structuring of the course catalog. For example, when training administrator 105 creates a new subject area represented by a course group, he can decide whether it should be accessible to learners 104 in the learning portal 202.

Reporting functions 214 in training management enable managers to keep track of learners' learning activities and the associated costs at all times. Supervisors or managers can monitor and steer the learning processes of their employees. They can be notified when their employees request participation or cancellation in courses and can approve or reject these requests. LMS 140 may provide the training manager with extensive support for the planning, organization, and controlling of corporate education and training. Trainers need to have up-to-the-minute, reliable information about their Course schedules. There is a wide range of reporting options available in training management to enable the trainer to keep track of participants, rooms, course locations, and so on.

Authoring environment 211 contains tools and wizards that content developers 106 and instructional designers can use to create or import external course content. External authoring tools can be launched directly via authoring environment 211 to create learning content that can be integrated into learning objects and combined to create complete courses (learning nets). Attributes may be appended to content, thereby allowing learners 104 to structure learning content more flexibly depending on the learning strategy they prefer. Customizable and flexible views allow subject matter experts and instructional designers to configure and personalize the authoring environment 211. To create the HTML pages for the content, the user can easily and seamlessly integrate editors from external providers or other content providers 108 into LMS 140 and launch the editors directly from authoring environment 211. Authoring environment 211 often includes a number of tools for creating, structuring, and publishing course content and tests to facilitate and optimize the work of instructional designers, subject matter experts, and training administrators 105. Authoring environment 211 may contain any number of components or sub-modules such as an instructional design editor is used by instructional designers and subject matter experts to create and structure learning content (learning nets and learning objects), a test author is used by instructional designers and subject matter experts to create web-based tests, and a repository explorer is for training administrators and instructional designers to manage content.

In the illustrated embodiment, course content is stored and managed in content management system 220. Put another way, LMS 140 typically uses the content management system 220 as its content storage location. But a WebDAV (Web-based Distributed Authoring and Versioning) interface (or other HTTP extension) allows integration of other WebDAV-enabled storage facilities as well without departing from the scope of this disclosure. Content authors or developers 106 publish content in the back-end training management system. Links to this content assist the training administrator 105 in retrieving suitable course content when planning web-based courses, A training management component of LMS 140 may help the training administrator 105 plan and create the course offering; manage participation, resources, and courses; and perform reporting. When planning e-learning courses, the training administrator 105 uses references inserted in published courses to retrieve the appropriate content in the content management system for the courses being planned. Content management system 220 may also include or implement content conversion, import, and export functions, allowing easy integration of Sharable Content Object Reference Model (SCORM)-compliant courses from external providers or other content providers 108.

LMS 140 and its implemented methodology typically structure content so that the content is reusable and flexible. For example, the content structure allows the creator of a course to reuse existing content to create new or additional courses. In addition, the content structure provides flexible content delivery that may be adapted to the learning styles of different learners. E-learning content may be aggregated using a number of structural elements arranged at different aggregation levels. Each higher level structural element may refer to any instances of all structural elements of a lower level. At its lowest level, a structural element refers to content and may not be further divided.

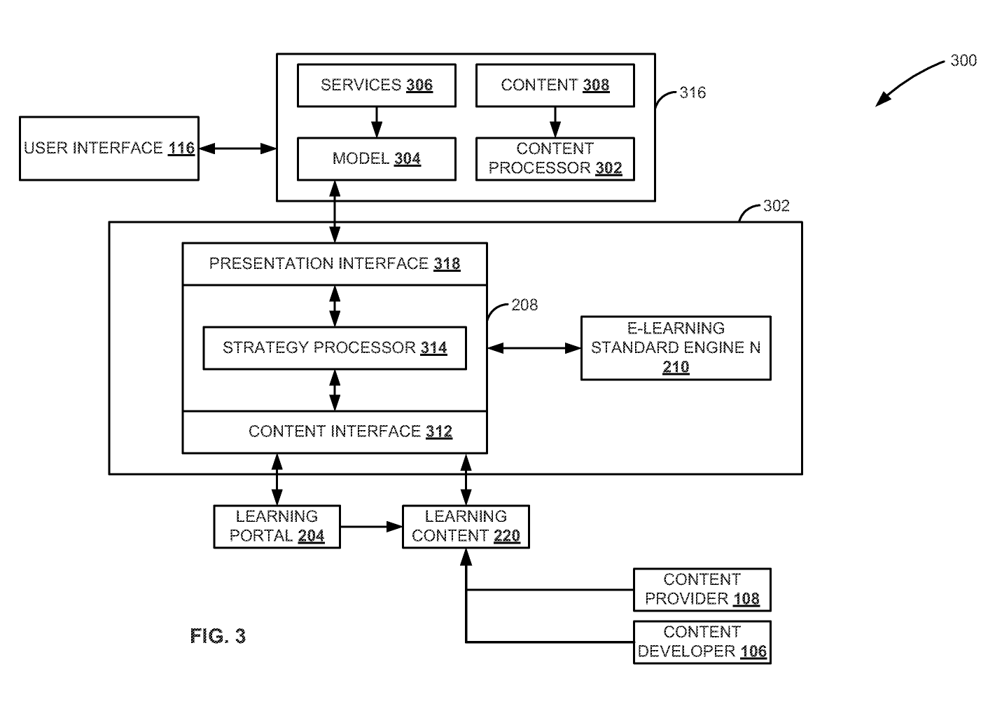

FIG. 3 illustrates a system 300 for presenting course content, perhaps using the foregoing strategies. Although the illustrated components are logically organized into groups for discussion purposes, components may be, for example, distributed on one or more computing devices connected by one or more networks, shared memory, inter-processor communication channels, or other suitable means. There may be more or fewer components without departing from the scope and spirit of this disclosure. An individual component's functionality can be distributed on one or more computing devices. For example, FIG. 2 illustrates LMS 140 including, among other things, content player 208, e-learning standard engines 210, and learning portal 204. This example learning portal 204 allows learner 104 to start a new course or continue a previously initiated course using content player 208. Both the learning portal 204 and the content player 208 can access learning content 220 (provided by content developer 106 or content provider 108) through objects or services in a runtime environment 302. Learning content 220 can be persisted in any number of ways including, for example, with one or more files, databases, repositories, virtual repositories, and content management systems. Content player 208 can include, present, or otherwise utilize user interface 116 to present representations of content including, for example, HTML, SGML, DHTML, XML, JavaScript or Flash.

By way of illustration, runtime environment 302 can provide the ability to create one or more processes, threads or other units of execution with access to local and remote resources/services (e.g., virtual memory, threads, processes, web services, user interface 116, learning content 220, and content provider 108), intra-process and inter-process communication facilities, authorization and authentication services, and/or exception handling. Runtime environment 302 can be distributed across one or more computing devices. In one implementation, the runtime environment 302 is the Java 2 Platform. Enterprise Edition (J2EE).

In a more detailed embodiment, the user interface 116 is communicably coupled to a presentation component 316 which is part of content player 208. Content player 208 includes, references, or otherwise presents a number of interface elements available for displaying or managing a course. For example, the topic of the course or learning object is displayed in the header in the upper part of the screen. The content of the learning object may be displayed in the center screen area. The navigation bar is located in the lower screen area and allows learner 104 to activate all of the navigation functions for a course. For example, content player 208 may present the following navigation controls or interface elements: back, next, table of contents, path, and others. In this example, the “back” interface element allows learner 104 to go back to the previous learning object Navigation steps from other sessions are also often taken into account at this point. The “next” interface element allows learner 104 to move on to the next object. This navigation may happen in a time axis according to the selected learning strategy governed by the e-learning standard. In short, if learner 104 navigates using “back,” then content player 208 goes back in this history. If learner 104 then navigates again with “next,” then content player 208 returns to the learning content that was most recently edited.

The “table of contents” element displays an overview of the content of a Course in the dialog box, the learning Objects are presented in the sequence in which the author created them. This view is often independent of the learning strategy of the conformant e-learning standard. In the table of contents, entries that learner 104 can access are usually highlighted in some fashion. Access to entries depends on the learner's completion status and the learning strategy dictated by the e-learning standard. The path interface element may allow learner 104 to know where he is in this course. A dialog box may appear with an overview of the course. The overview may depend on the learning strategy selected, if the course was started from learning portal 204, then the learning strategy selected in the portal is displayed in the dialog box. If the course was started from authoring environment 211, then the selected macro strategy (perhaps with its corresponding micro strategy) may be displayed in the dialog box. In the upper part of the dialog box, the system displays the instructional elements or other content in the current learning object. In the lower part of the screen, learning objects and learning nets that are in the environment of the current path are displayed on a dark background.

As above, elements that learner 104 has already displayed or completed and the learning object currently in process may be flagged accordingly. Other example interface elements include settings, print, help, and log off. The settings element allows learner 104 to reset progress already attained in a course. The print element prints out the content of a course. In certain case, the print element only prints the page that is currently displayed. The navigation and the path may not be printed as appropriate. The help interface element presents a dialog box that displays learner-specific help for, inter alia, navigating in the content player 208. The example log off element allows learner 104 to log off in a controlled fashion. In this case, the achieved learning objectives are entered in the learner account and the system saves the point at which the course was interrupted to help ensure that the learner can resume at the same point. After logging off, the dialog box is usually closed if the course was started from the portal and has been fully completed.

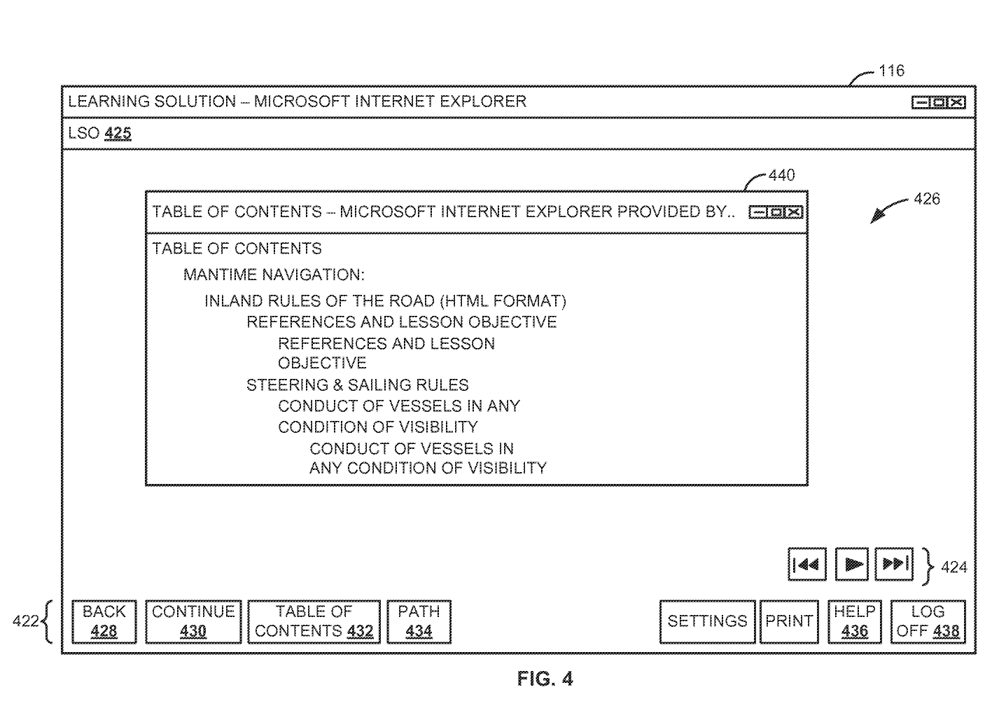

Returning to the illustrated embodiment, presentation component 316 interacts with the user interface 116 to manifest course content in a presentation 426 (such as that illustrated in FIG. 4) and to receive user input. The presentation component 316 receives the content 308 from content player 208, a web service, cache file, or other suitable source. The content 308 can include discrete or streaming portions and may include one or more content representations, in one embodiment, the presentation component 316 is a web browser or other suitable application, or a proxy for such.

In presenting content 308, the presentation component 316 can also present one or more user interface elements 422 in a footer area. The presentation component 316 can also present a header area 425 for displaying messages or status. In certain cases, content 308 may include its own interface elements 424 that are in addition to or redundant to those present by content player 208. See FIG. 4. The user interface elements 422 (or “navigation controls”) allow a user to navigate the course content 308, for example. Course navigation can be set up at runtime on the basis of a learning strategy provided by the e-learning standard engine 210. The navigation controls 422 are separate from, and may be in addition to, any such elements that are presented as part of the content presentation 426. For example, if the content representation 308 includes a Flash presentation, the presentation 426 can include its own user interface elements 424 for controlling the presentation, apart from the navigation controls 422. Back button 428 user interface element allows the user to move backwards through the course. A continue button 430 alternately allows the user to pause and resume the course. Selecting a table of contents button 432 presents a table of contents for the course which can allow the user to directly navigate to a section of interest. A path button 434 allows the user to view their current path through a course. A settings button, a print button, a help button 436, a path button 434, and a log off button 438 enable the user to change settings for the content player, print some or of the course content, invoke a help system and log off from the content player, respectively. The forgoing descriptions of user interface elements 422 are merely examples of possible implementations. Many other types of user interface elements and configurations are possible within the scope of the present disclosure.

Referring again to FIG. 3, presentation component 316 includes a content processor 302 which can process content 308. Content processor 302 can perform any processing of the content 308 to create or update the content presentation 426, in one embodiment, content processor 302 parses one or more portions of content 308 where the content can include, without limitation, HTML, SGML, DHTML, XML, JavaScript or Flash or suitable formats. In one embodiment, content processor 302 can be implemented as a web browser plug-in or an applet. Content processor 302 can modify a model 304 of the user interface 116 in order to affect the user interface 116. The model 304 can be a hierarchical representation of the components comprising the rendered user interface 116. Changes to the model 304 can be automatically reflected in the rendered user interface 116. In one implementation, the model 304 is a Document Object Model (DOM).

In one embodiment, these commands may be provided through services 306. The services can include functionality for creating, destroying, altering, enabling, disabling, hiding or showing navigation controls 422. The services 308 can include an application programming interface (API) or other suitable programmatic means for altering the model. This API may offer developer 106 the option of steering or modifying the user interface of content player from the content by providing a number of functions that can be executed dynamically at runtime from the content. For example, developer 106 might decide to hide the navigation bar or the header completely. In another example, learners 104 often steer their progress through a course or its table of contents triggered by the content. Equally, developer 106 can steer from the content, thus automatically guiding learner 104 through the course without some or all of the ability to influence the sequence. These services 306 can be invoked by the content processor 302 before, during or after processing the content 308 and in accordance to commands encountered in the content 308.

By way of a non-limiting illustration, the services can be used to hide navigation controls 422 when user interface elements 424 are present, or perform navigation of the content without requiring presentation of the navigation controls 422. Doing so may prevent users from becoming confused by the presentation of two sets of controls (422, 424). FIG. 4 illustrates the user interface 116 displaying a table of contents 440 created as a result of the command(s), which could have alternatively been presented if the user had selected button 432. By way of further illustration, commands in the content 308 can automatically trigger navigation of course content without requiring the navigation controls 422 to be presented. For example, when a user completes a course, command(s) in the content can trigger navigation of the 116.

The presentation component 316 is communicably coupled to content player 208 or a proxy for such. A content interface 312 in the content player 208 allows the content player 208 to access learning content 220, content provider 108, or other sources of content. The content interface 312 presents a uniform interface to the content player 208 regardless of the particulars of the learning content 220. The content interface 312 can include, by way of illustration, an API or other suitable means that implements or uses a communication protocol between the content player 208 and the learning content 220.

A strategy processor component 314 of the content player 208 can be used to integrate the content player 208 with any of the e-learning standard engine 210. As described above, content metadata may be interpreted to present a course to learner 104 according to a learning strategy provided by the e-learning standard engine 210 currently integrated with the content player 208. Metadata can classify and describe structural course content elements, assign attributes to structural elements, assign relations between structural elements, and build a subject-taxonomic course structure. Further, the strategy processor 314 can tailor content retrieved through the content interface 312 to the needs of an individual learner 104 and establish course navigation according to the learning strategy provided by the e-learning standard engine 210. The strategy processor provides course content 308 with navigation info to the presentation component 316, in one embodiment, the course content can contain one or more commands to modify the user interface elements 422.

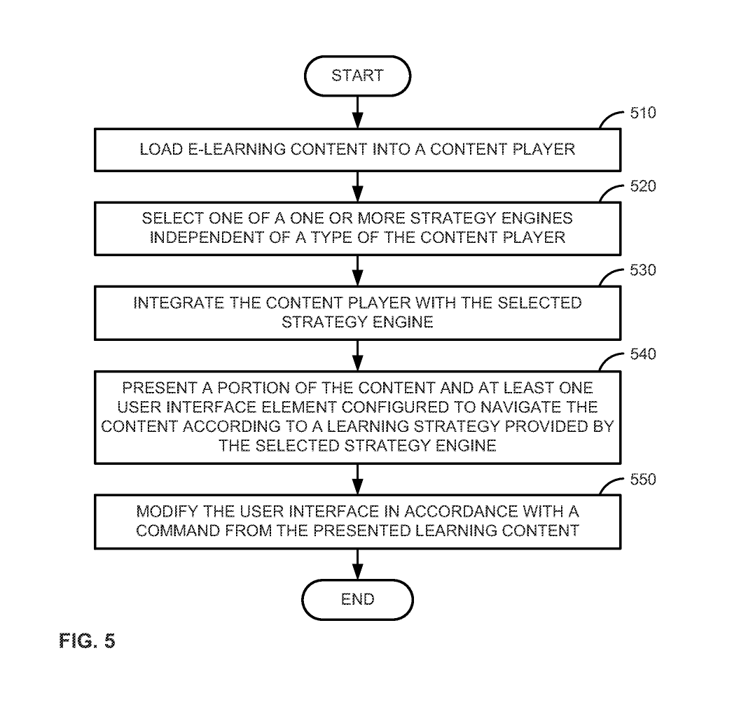

FIG. 5 is a flow diagram 500 of a process of implementing e-learning techniques using independent e-learning standard engines in accordance with various embodiments. The method implemented by a computer or any other electronic device having processing capabilities, includes at least the following process illustrated with reference to process blocks 510-550. In an embodiment, the method includes loading e-learning content into a content player. The term “content” as used herein refers to e-learning standard compliant content, e.g., SCORM course. The content includes one or more representations of a course of study, and one or more commands for modifying the user interface 116. Content 308 can contain commands, metadata or other information that can be used to trigger modification of user interface 116, including modification (such as disabling, triggering, moving, resizing, and others) of navigation controls 422, header 425 and other interface elements. By way of a non-limiting illustration, a command can be one or more statements in a programming language, metadata, an identifier, or other information that is part of the content 426. In one embodiment, the commands are JavaScript statements that cause the invocation of JavaScript functions.

At process block 520, one of several strategy engines are selected, where the strategy engines (e-learning standard engines) are provided as independent tools outside the content player. The strategy engines serve as tools for developing the program logic for a learning strategy, based on the specifications of an e-learning standard specification such as SCORM. Learning strategies may be created using specification defined by an e-learning standard. These learning strategies may be accessed at run time of the presentation of course content to the content player 208 from a e-learning standard engine 210. As result, course authors 106 may be relieved from the burden of determining a sequence or an order of presentation of the course material. Instead, developers 106 may focus on structuring and annotating the course material. Further, the learning strategy provided by the e-learning standard engine 210 determines the sequence that sub-courses and learning units of a course are presented to the learner. For example, content player 208 uses the learning strategy to determine the sequence in which learning objects are displayed in the browser.

At process block 530, the content player is integrated with the selected strategy engine using any industry standard integration technique such as Web Services.

In another aspect, at process block 540, a portion of the content and one or more user interface elements are presented on the user interface, where the one or more user interface elements are configured to navigate the content according to a learning strategy provided by the selected strategy engine.

Further, at process block 550, the user interface of the content player is modified in accordance with a command from the learning content, where the user interface includes a plurality of interface elements and at least a subset of the interface elements comprising navigational controls for controlling the learning content. For example, a designer of the instructional element, such as developer 106, may determine that the content needs more screen space; in this case, he can allow or design the content to include commands to turn off the navigation and the header bar. In a further example, if the instructional element includes some form of test that should be passed before learners 104 are allowed to navigate forward, then the instructional element or other portion of the content may be designed to include commands to turn off (or otherwise disable) the navigation bar until the test is passed. In yet another example, if an instructional element determines that it should display a portion or the entire table of contents for some learning content, then it may read it in XML format and automatically render it accordingly. Of course, while content control of certain portions of the content player is described in terms of learning content and learning systems, such content control may be implemented in other media content and format, including music, video, and such.

A number of embodiments have been described. Nevertheless, it will be understood that various modifications may be made without departing from the spirit and scope of the disclosure. For example, as described earlier, such content control techniques may be implemented in various systems, such as enterprises or home user computers, presenting or developing any suitable content. Indeed, such content may not be related to “learning,” but may instead involve entertainment and sports, presentations, marketing, or any other suitable media or environment. Accordingly, other embodiments are within the scope of the following claims.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

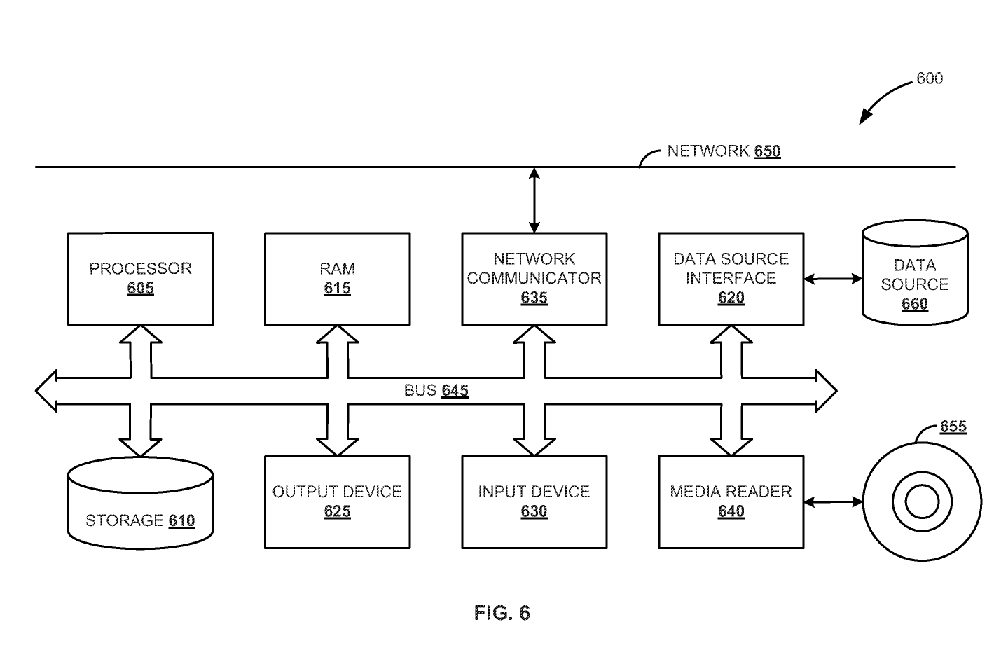

FIG. 6 is a block diagram of an exemplary computer system 600. The computer system 600 includes a processor 605 that executes software instructions or code stored on a computer readable storage medium 655 to perform the above-illustrated methods. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed by network 650. In some embodiments the data source 660 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like, Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible within the scope of the disclosure, as those skilled in the relevant art will recognize. These modifications can be made in light of the above detailed description. Rather, the scope is to be determined by the following claims, which are to be interpreted in accordance with established doctrines of claim construction.

1. An electronic learning system comprising:
memory storing a plurality of learning content;
a content player;
one or more strategy engines communicatively coupled to the content player; and
one or more processors performing the following operations:
loading content into a content player;
selecting one of the one or more strategy engines independent of a type of the content player;
integrating the content player with the selected strategy engine;
presenting a portion of the content and at least one user interface element on a user interface, the at least one user interface element configured to navigate the content according to a learning strategy provided by the selected strategy engine; and
modifying the user interface of the content player in accordance with a command from the learning content, where the user interface comprising a plurality of interface elements and at least a subset of the interface elements comprising navigational controls for controlling the learning content.

2. The system of claim 1, where the content is associated with one or more of the following representations: HTML, SGML, DHTML, XML, JavaScript, or Flash.

3. The system of claim 1 wherein the user interface is configured to navigate to different learning content in accordance with the command from the learning content.

4. The system of claim 1, wherein modifying the user interface comprises automatically navigating between a first component and a second component of the content.

5. The system of claim 1, wherein modifying the user interface comprises disabling one or more of the interface elements.

6. The system of claim 1, where the command is one or more statements in a scripting language embedded in the content.

7. The system of claim 1, where the command is a method call exposing a common API for content control.

8. The system of claim 1, wherein the learning content comprises one or more commands established according to the selected learning strategy.

9. The system of claim 1, wherein the learning strategy is in compliance with one of a Sharable Content Object Reference Model (SCORM) specification and an Aviation Industry CBT Committee (AICC) specification.

10. A computer-implemented method comprising:
loading learning content into a content player;
selecting a strategy engine of one or more strategy engines, wherein the selecting is independent of a type of the content player;
integrating the content player with the selected strategy engine;
presenting a portion of the content and at least one user interface element on a user interface, the at least one user interface element configured to navigate the content according to a learning strategy provided by the selected strategy engine; and
modifying the user interface of the content player in accordance with a command from the learning content, the user interface comprising a plurality of interface elements and at least a subset of the interface elements comprising navigational controls for controlling the learning content.

11. The method of claim 10, wherein modifying the user interface comprises disabling at least one of the plurality of interface elements.

12. The method of claim 10, wherein modifying the user interface comprises automatically navigating between a first component and a second component of the content.

13. The method of claim 10, wherein the one or more strategy engines are each configured to play content according to a program logic defined by an e-learning standard specification that is distinct from each of the other one or more strategy engines.

14. The method of claim 10, wherein the user interface is configured to navigate different learning content in accordance with the command from the learning content.

15. The method of claim 10, where the command is one or more statements in a scripting language embedded in the content.

16. The method of claim 10, where the command is a method call exposing a common API for content control.

17. The method of claim 10, wherein the learning content comprises one or more commands established according to the selected learning strategy.

18. The method of claim 10, wherein the one or more strategy engines are integrated with the content player using web services.

19. The method of claim 10, wherein the content player is a mobile-based e-learn content player.

20. A computer program product, comprising:
a computer readable storage medium having instructions which when executed by a computer causes the computer to:
loading learning content into a content player;
selecting a strategy engine of one or more strategy engines, wherein the selecting is independent of a type of the content player, wherein the one or more strategy engines are each configured to play content according to a program logic defined by an e-learning standard specification that is distinct from each of the other one or more strategy engines;
integrating the content player with the selected strategy engine;
presenting a portion of the content and at least one user interface element on a user interface, the at least one user interface element configured to navigate the content according to a learning strategy provided by the selected strategy engine; and
modifying the user interface of the content player in accordance with a command from the learning content, the user interface comprising a plurality of interface elements and at least a subset of the interface elements comprising navigational controls for controlling the learning content.
